(19) United States
(12) Patent Application Publication
(10) Pub. No.: US 2024/0020872 A1
(43) Pub. Date: Jan. 18, 2024

(54) PROVISION OF AUDIO AND VIDEO STREAMS BASED ONHAND DISTANCES

(71) Applicant: HEWLETT-PACKARD DEVELOPMENT COMPANY, L.P., Spring, TX (US)

(72) Inventor: Rafael DAL ZOTTO, Porto Alegre (BR)

(21) Appl. No.: 17/866,265

(22) Filed: Jul. 15, 2022

(51) Int. Cl. G06T 7/73; G06V 40/10; G01B 11/02; H04N 7/15

(52) U.S. Cl. CPC G06T 7/73; G06V 40/113; G01B 11/026; H04N 7/15

(57) ABSTRACT

In some examples, a non-transitory, computer-readable medium stores executable code, which, when executed by a controller of an electronic device, causes the controller to: obtain an image of a human hand from a video stream captured by a camera; and control provision of the video stream, an audio stream, or a combination thereof to a network based on a distance of the human hand from the camera as determined using the image.

### BACKGROUND

Electronic devices such as laptops, notebooks, desktops, tablets, and smartphones may include applications that enable persons in differing locations to participate in video conferences. Attendees participating in a video conference may exchange audio signals to facilitate oral conversations. Further, attendees participating in the video conference may exchange video signals so the attendees can see each other. Audio signals may be captured, for example, using a microphone, and video signals may be captured, for example, using a camera (e.g., a webcam).

### BRIEF DESCRIPTION OF THE DRAWINGS

Various examples will be described below referring to the following figures:

FIG. 1 is a block diagram of an electronic device in accordance with various examples.

FIG. 2 is a schematic diagram of landmarks on an image of a human hand captured by an electronic device camera, in accordance with various examples.

FIG. 3 is a schematic diagram of landmarks corresponding to a human hand, in accordance with various examples.

FIG. 4 depicts the provision of a captured image to a display responsive to a distance between hand landmarks being below a threshold, in accordance with various examples.

FIG. 5 depicts the provision of a substitute image to a display responsive to a distance between hand landmarks being at or above a threshold, in accordance with various examples.

FIGS. 6 and 7 are flow diagrams of methods in accordance with various examples.

FIGS. 8 and 9 are block diagrams of non-transitory, computer-readable media in accordance with various examples.

### DETAILED DESCRIPTION

As described above, electronic devices such as laptops, notebooks, desktops, tablets, and smartphones may include applications that enable persons in differing locations to participate in video conferences. Attendees participating in a video conference may exchange audio signals to facilitate oral conversations. Further, attendees participating in the video conference may exchange video signals so the attendees can see each other. Audio signals may be captured, for example, using a microphone, and video signals may be captured, for example, using a camera (e.g., a webcam).

In addition to capturing an attendee's voice, a microphone also may undesirably capture aural aspects of the attendee's environment, such as noise from nearby construction, televisions, radios, family members, and pets. Similarly, in addition to capturing an attendee's face, a camera also may undesirably capture visual aspects of the attendee's environment, such as office furniture, family members, and pets. Although attendees may temporarily disable their cameras and microphones, for example when taking a restroom or snack break or to avoid socially embarrassing situations, doing so is often tedious and entails an undesirable amount of interaction with an application user interface presented on a display. A quick, easy, and intuitive technique for enabling and disabling cameras and microphones during video conferences is desirable.

This disclosure describes various examples of a controller of an electronic device (e.g., a desktop, laptop, notebook, tablet, or smartphone) that is to control provision of audio signals (from a microphone of the electronic device), video signals (from a camera of the electronic device), or a combination thereof to a network based on a distance of a user's hand from the camera. Because the distance between any two landmarks on the user's hand increases as the hand is brought closer to the camera and decreases as the hand is taken away from the camera, this distance is useful as a proxy for the distance between the user's hand and the camera. Accordingly, in examples, the controller may capture a video stream from the camera and may obtain an image of the user's hand from the video stream. The controller may determine a distance between first and second landmarks on the image of the user's hand. Responsive to the distance between the first and second landmarks exceeding a threshold (meaning that the hand is close to the camera), the controller is to stop providing the audio signals, video signals, or a combination thereof to the network. In examples, the controller is to provide alternative audio signals, alternative video signals, or a combination thereof to the network in lieu of the audio and/or video signals captured by the microphone and/or camera of the electronic device. In addition to or in lieu of ceasing to provide audio signals to the network, the controller is to mute the microphone until the user's hand indicates that the user is ready to resume sharing audio signals. Responsive to the distance between the first and second landmarks not exceeding a threshold (meaning that the hand is far from the camera), the controller is to resume providing the audio signals, video signals, or a combination thereof to the network.

In this way, a user attending a video conference may stop sharing audio and video signals with other attendees by positioning her hand close to the camera, and the user may resume sharing audio and video signals with other attendees by positioning her hand away from the camera. This controller thus provides a quick, easy, and intuitive technique for enabling and disabling cameras and microphones during video conferences.

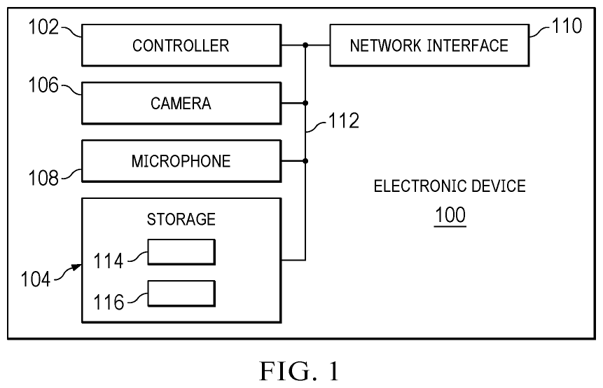

FIG. 1 is a block diagram of an electronic device 100 in accordance with various examples. The electronic device 100 may be a laptop computer, a desktop computer, a notebook, a tablet, a server, a smartphone, or any other suitable electronic device having a camera and capable of participating in videoconferencing sessions. The electronic device 100 may include a controller 102 (e.g., a central processing unit (CPU); a microprocessor), a storage 104 (e.g., random access memory (RAM), read-only memory (ROM)), a camera 106 to capture images and video in an environment of the electronic device 100, a microphone 108 to capture audio in an environment of the electronic device 100, and a network interface 110. The network interface 110 enables the controller 102, the camera 106, and/or the microphone 108 to communicate with other electronic devices external to the electronic device 100. For example, the network interface 110 enables the controller 102 to transmit signals to and receive signals from another electronic device over the Internet, a local network, etc., such as during a videoconferencing session. A bus 112 may couple the controller 102, storage 104, camera 106, microphone 108, and network interface 110 to each other. Storage 104 may store executable code 114 (e.g., an operating system (OS)) and executable code 116 (e.g., an application, such as a videoconferencing application that facilitates videoconferencing sessions with electronic devices via the network interface 110). In examples, the camera 106 may capture and store images and/or video (which is a consecutive series of image frames) to the storage 104. In examples, the microphone 108 may capture and store audio to the storage 104. In examples, the storage 104 includes one or more buffers to temporarily store image and/or video captured by the camera 106 and/or audio captured by the microphone 108.

In operation, the controller 102 executes the executable code 116 to participate in a videoconferencing session. As the controller 102 executes the executable code 116, the controller 102 receives images and/or video captured by the camera 106 and/or audio captured by the microphone 108 and provides the image, video, and/or audio data to the network interface 110 for transmission to another electronic device that is participating in the videoconferencing session with the electronic device 100.

As described above, a user of the electronic device 100 may be participating in the videoconferencing session and may wish to halt transmission of the aforementioned image, video, and/or audio data via the network interface 110. Accordingly, the user may position her hand in front of the camera 106. Responsive to the user positioning her hand close to the camera 106, the controller 102 may stop transmission of image, video, and/or audio data via the network interface 110. When such transmission is halted, the electronic device 100 is said to be in a break mode. Conversely, responsive to the user positioning her hand far away from the camera 106, the controller 102 may resume transmission of image, video, and/or audio data via the network interface 110. When such transmission is not halted, the electronic device 100 is said to be in a primary mode.

In other examples, responsive to the user positioning her hand close to the camera 106 during the videoconferencing session, the controller 102 may switch modes (e.g., if the electronic device 100 is in the primary mode, the controller 102 switches the electronic device 100 to the break mode by halting transmission of image, video, and/or audio data via the network interface 110; if the electronic device 100 is in the break mode, the controller 102 switches the electronic device 100 to the primary mode by resuming transmission of image, video, and/or audio data via the network interface 110). Conversely, in such examples, responsive to the user positioning her hand away from the camera 106, the controller 102 may maintain a current mode (e.g., if the electronic device 100 is in the primary mode, it remains in the primary mode, and if the electronic device 100 is in the break mode, it remains in the break mode), thereby enabling the user to, e.g., engage in friendly hand-waving during videoconferencing sessions.

To determine whether the user's hand is close to or far away from the camera 106, the controller 102 is to use a machine learning technique to identify landmarks on an image of the user's hand and to measure a distance between a pair of predetermined landmarks. For example, the controller 102 may receive an image of the user's hand from the camera 106 and may identify a first landmark at the base of the index finger and a second landmark at the base of the pinky finger. The controller 102 may measure a distance between the first and second landmarks. As the user's hand gets closer to the camera 106, this distance increases because the user's hand appears larger to the camera 106. Conversely, as the user's hand gets farther away from the camera 106, this distance decreases because the user's hand appears smaller to the camera 106. Accordingly, the controller 102 may measure this distance between the first and second landmarks and compare the distance to a threshold. If the distance meets or exceeds the threshold, the controller 102 may conclude that the distance between the camera 106 and the hand is small (e.g., the user is trying to enable the break mode or to toggle between modes as described above), and if the distance falls below the threshold, the controller 102 may conclude that the distance between the camera 106 and the hand is large (e.g., the user is trying to enable the primary mode or to continue with whichever mode is currently enabled, as described above).

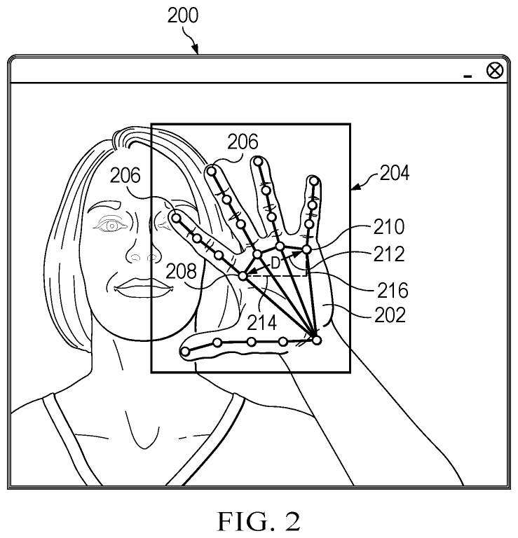

FIG. 2 is a schematic diagram of landmarks on an image of a human hand captured by an electronic device camera, in accordance with various examples. Specifically, FIG. 2 includes an image 200 captured by the camera 106 (FIG. 1). The controller 102 may obtain (e.g., intercept) the image 200 after the image 200 is captured by the camera 106 using any suitable technique, such as a DRIVER DEVICE TRANSFORM® (e.g., DEVICEMFT®), proxy camera techniques, etc. The image 200 may include a user's hand 202.

After obtaining the image 200 from the camera 106, the controller 102 may apply a suitable machine learning technique, such as a hand landmark model (e.g., MEDIAPIPE® HANDS®), to identify the hand 202 in the image 200, as bounding box 204 shows. After identifying the hand 202 in the image 200, the controller 102 may use the machine learning technique to identify multiple landmarks 206 on the hand 202 in the image 200. As shown, such landmarks 206 may include multiple landmarks on each digit of the hand 202 and multiple landmarks on the palm of the hand 202. The executable code 116 may be programmed to identify particular ones of the landmarks 206 so that, after determining a distance between the particular landmarks, the distance may be compared to a standardized threshold. For example, the controller 102 may identify the landmarks 206 and then may specifically identify a landmark 208 that is located at a base of the index finger and a landmark 210 that is located at a base of the pinky finger. The scope of disclosure is not limited to the identification and use of any particular pair of landmarks 206.

After identifying the landmarks 208, 210, the controller 102 may determine a distance 212 between the landmarks 208, 210. To determine the distance 212, the controller 102 may apply the Pythagorean Theorem by applying a triangular geometric model to the hand 202, such as by determining lengths of sides 214, 216. The lengths of the sides 214, 216 may be applied to the Pythagorean Theorem to determine the distance 212. In some examples, all distances and lengths are measured and/or expressed in terms of pixels, although the scope of this disclosure is not limited as such. The controller 102 may subsequently compare the distance 212 to a threshold, and depending on the result of the comparison, the controller 102 may enable the break mode (e.g., halting transmission of image, video, and/or audio data via the network interface 110), enable the primary mode (e.g., enabling transmission of image, video, and/or audio data via the network interface 110), or maintain the current mode. In examples, enabling the break mode may include halting transmission of image and/or video data via the network interface 110. In examples, enabling the break mode may include muting the microphone 108. In examples, enabling the break mode may include not muting the microphone 108 but not providing captured audio data to the network interface 110.

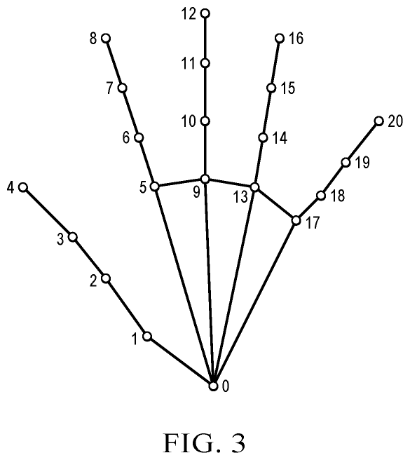

FIG. 3 is a schematic diagram of landmarks corresponding to a human hand, in accordance with various examples. Example landmarks may include landmark 0, which is located at a base of the palm; landmarks 1-4, which are distributed from the proximal thumb to the distal thumb; landmarks 5-8, which are distributed from the proximal index finger to the distal index finger; landmarks 9-12, which are distributed from the proximal middle finger to the distal middle finger; landmarks 13-16, which are distributed from the proximal ring finger to the distal ring finger; and landmarks 17-20, which are distributed from the proximal pinky finger to the distal pinky finger. Landmarks 0, 1, 5, 9, 13, and 17 may be located on the palm, with landmarks 1, 5, 9, 13, and 17 located at the bases of the thumb, index, middle, ring, and pinky fingers, respectively. The measurement of inter-landmark distances, as described above (e.g., distance 212), may be performed between any pair of landmarks. Because the distances between different landmark pairs may vary vis-à-vis a threshold to which such distances are compared, in examples, a user may configure the electronic device 100 to identify and measure a distance between a specific landmark pair. In examples, an engineer or programmer of the electronic device 100 may configure the electronic device 100 to identify and measure a distance between a specific landmark pair. In examples, because hand sizes may vary across users, a threshold to which a measured or calculated distance may be compared may be programmed into the electronic device 100 on a user-by-user basis. For example, the user may participate in a training session with the electronic device 100 during which the user's hand is measured and a threshold is set against which inter-landmark distances may subsequently be compared.

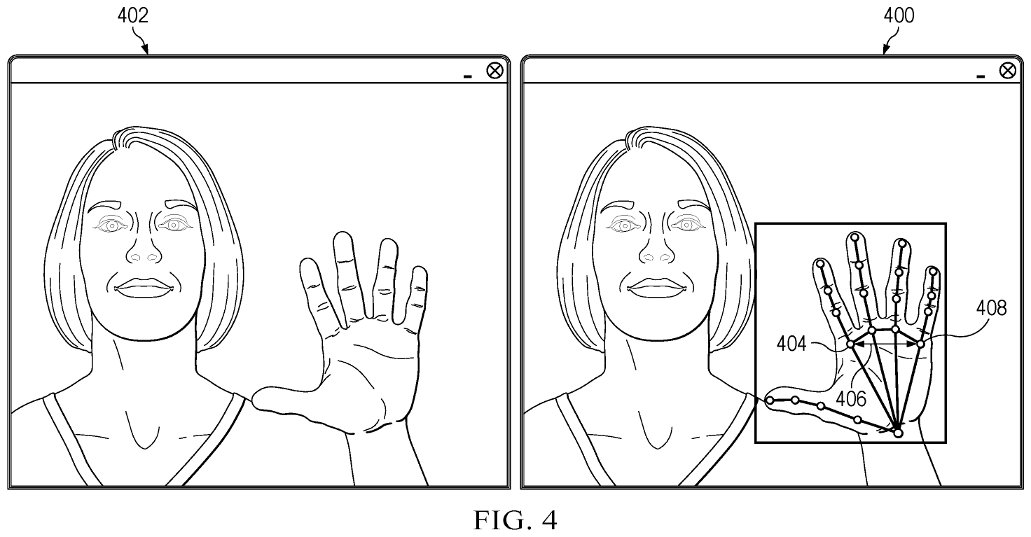

FIG. 4 depicts the provision of a captured image to a display responsive to a distance between hand landmarks being below a threshold, in accordance with various examples. As described above, when the inter-landmark distance is less than a programmed threshold (e.g., programmed by a user; programmed by a software designer or engineer), the distance between the camera 106 and the user's hand is determined to be large, meaning that the user is attempting to hold her hand “away” from the camera 106. For instance, in captured image 400, a distance 406 between landmarks 404 and 408 may be 85 pixels. A distance 406 of 85 pixels may fall below a threshold programmed into the electronic device 100, and so the controller 102 may take action accordingly. Specifically, in some examples, the electronic device 100 may disable break mode and enable the primary mode. In other examples, the electronic device 100 may continue operating in the current mode, whether that is the primary mode or break mode. In the specific example shown in image 402 of FIG. 4, a large distance between the camera 106 and the user's hand results in the electronic device 100 remaining in primary mode (e.g., video captured by the camera 106 continues to be provided to the network interface 110).

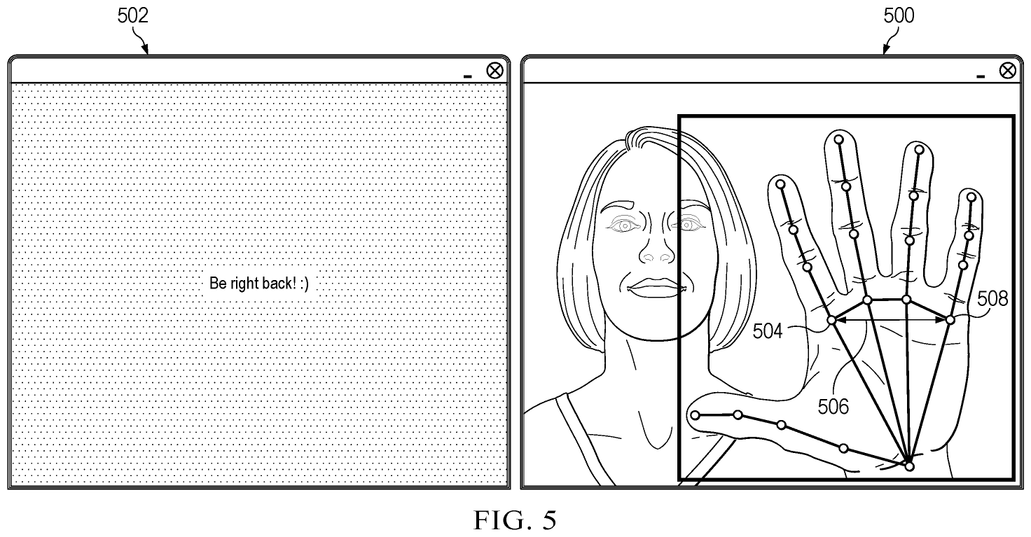

FIG. 5 depicts the provision of a substitute image to a display responsive to a distance between hand landmarks being at or above a threshold, in accordance with various examples. As described above, when the inter-landmark distance is equal to or greater than the programmed threshold, the distance between the camera 106 and the user's hand is determined to be small, meaning that the user is attempting to hold her hand “close” to the camera 106. For instance, in captured image 500, a distance 506 between landmarks 504 and 508 may be 155 pixels. A distance 506 of 155 pixels may exceed the threshold programmed into the electronic device 100, and so the controller 102 may take action accordingly. Specifically, in some examples, the electronic device 100 may disable primary mode and enable break mode. In other examples, the electronic device 100 may toggle modes such that if primary mode is enabled, the primary mode is disabled and break mode is enabled, and such that if break mode is enabled, the break mode is disabled and primary mode is enabled. In the example of FIG. 5, as image 502 shows, because the distance 506 exceeds the programmed threshold, the break mode is enabled.

In examples, and as described above, enabling break mode may include halting the provision of image, video, and/or audio data to the network interface 110. In some examples, enabling the break mode may also include the provision of substitute image, video, and/or audio data to the network interface 110. For instance, in lieu of sending image and/or video data captured by the camera 106, the controller 102 may instead send substitute image and/or video data to the network interface 110, such as screensaver images or videos, personalized messages, humorous images or videos, etc. Any and all suitable image and/or video data may be used as substitute image and/or video data. Similarly, in lieu of sending audio data captured by the microphone 108, the controller 102 may instead send substitute audio data to the network interface 110, such as classical music, personalized audio messages, etc. Any and all suitable audio data may be used as substitute audio data. Such substitute image, video, and/or audio data may be stored in and obtained from storage 104, obtained from the Internet via the network interface 110, etc.

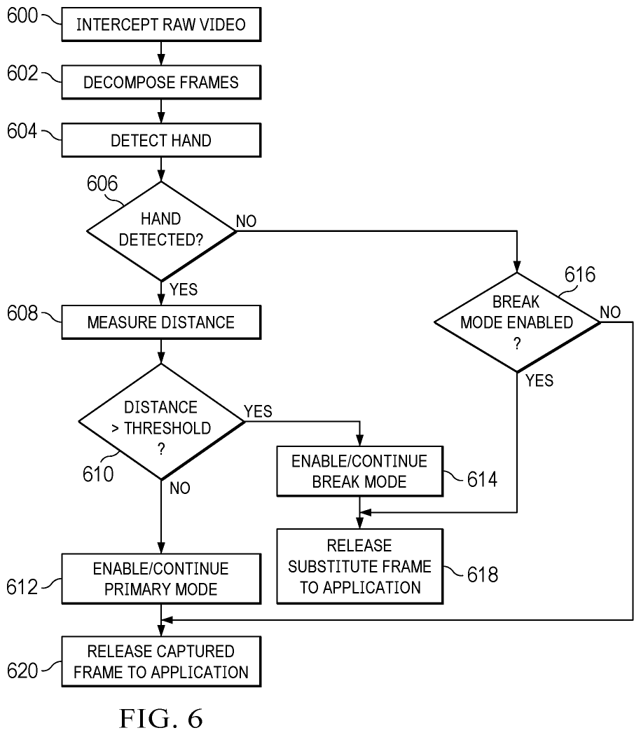

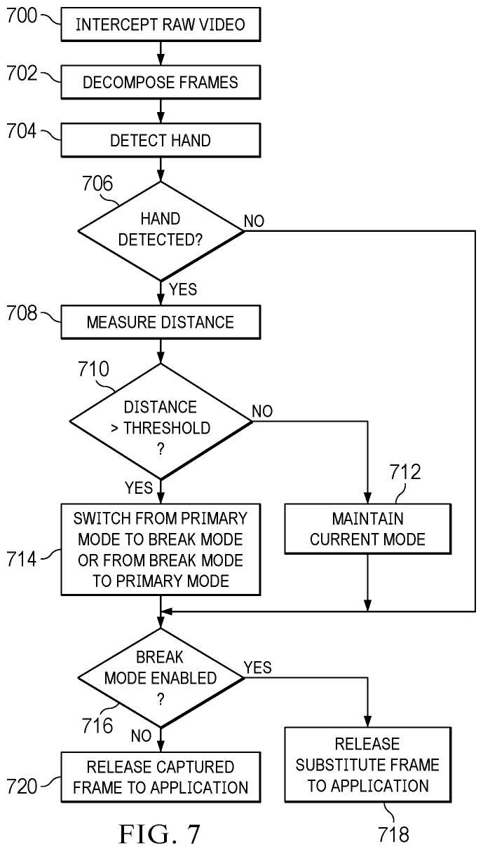

FIGS. 6 and 7 are flow diagrams of methods 600 and 700 in accordance with various examples. The controller 102 may perform the methods 600 and 700 as a result of executing the executable code 116, for example. The method 600 includes the controller 102 intercepting video data from the camera 106 (600). The method 600 includes the controller 102 decomposing the frames of the video data to obtain individual image frames (602). The method 600 includes the controller 102 detecting a hand in an individual image frame of the video data using a suitable machine learning technique (604). If a hand is detected (606), the method 600 includes the controller 102 measuring an inter-landmark distance as described above (608). If the inter-landmark distance is greater than (or equal to) a programmed threshold (610), the method 600 includes the controller 102 enabling the break mode or continuing in the break mode (614). Because the break mode is enabled, the controller 102 releases a substitute image frame to the executable code 116 (e.g., to the videoconferencing application) (618), thereby causing a substitute image frame to be transmitted via the network interface 110 as described above. The controller 102 may also provide substitute audio or no audio to the network interface 110, as described above. Otherwise, if the inter-landmark distance does not exceed the programmed threshold (610), the method 600 includes the controller 102 enabling the primary mode or continuing in the primary mode (612). Because the primary mode is enabled, the controller 102 releases the captured image frame (and captured audio) to the application (620), thereby causing the captured image frame (and captured audio) to be transmitted via the network interface 110 as part of a video stream (and audio stream). If a hand is not detected (606), the method 600 includes the controller 102 determining whether the break mode is enabled (616). If so, the method 600 includes the controller 102 releasing a substitute image frame (and substitute audio or no audio) to the executable code 116 (e.g., to the videoconferencing application) (618), thereby causing a substitute image frame (and substitute audio or no audio) to be transmitted via the network interface 110 as described above. Otherwise, if break mode is not enabled (616), the method 600 includes the controller 102 releasing the image frame captured by the camera 106 and the audio captured by the microphone 108 to the application (620), thereby causing the captured image frame and audio to be transmitted via the network interface 110 as part of a video stream and audio stream.

In FIG. 7, the method 700 includes the controller 102 intercepting video data from the camera 106 (700). The method 700 includes the controller 102 decomposing the frames of the video data to obtain individual image frames (702). The method 700 includes the controller 102 detecting a hand in an individual image frame of the video data using a suitable machine learning technique (704). If a hand is detected (706), the method 700 includes the controller 102 measuring an inter-landmark distance as described above (708). If the inter-landmark distance is greater than (or equal to) a programmed threshold (710), the method 700 includes the controller 102 switching (toggling) from the primary mode to the break mode, or if the break mode is enabled, then from the break mode to the primary mode (714). Otherwise, if the inter-landmark distance does not exceed the programmed threshold (710), the method 700 includes the controller 102 maintaining a current mode (712). If a hand is not detected (706), the method 700 includes the controller 102 determining whether the break mode is enabled (716). If so, the method 700 includes the controller 102 releasing a substitute image frame (and substitute audio or no audio) to the executable code 116 (e.g., to the videoconferencing application) (718), thereby causing a substitute image frame (and substitute audio or no audio) to be transmitted via the network interface 110 as described above. Otherwise, if break mode is not enabled (716), the method 700 includes the controller 102 releasing the image frame captured by the camera 106 and the audio captured by microphone 108 to the application (720), thereby causing the captured image frame and captured audio to be transmitted via the network interface 110 as part of a video stream and audio stream. After the controller 102 performs 712 or 714, control of the method 700 is provided to 716.

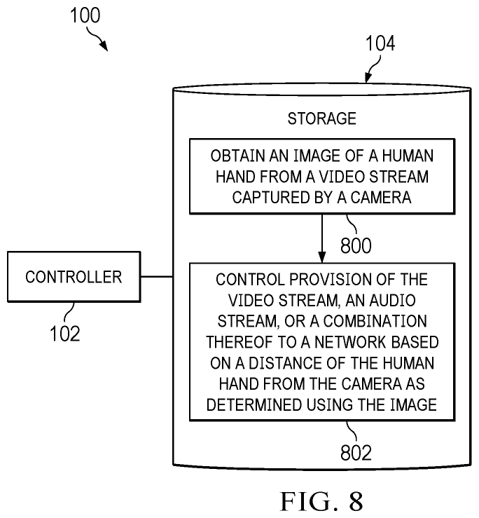

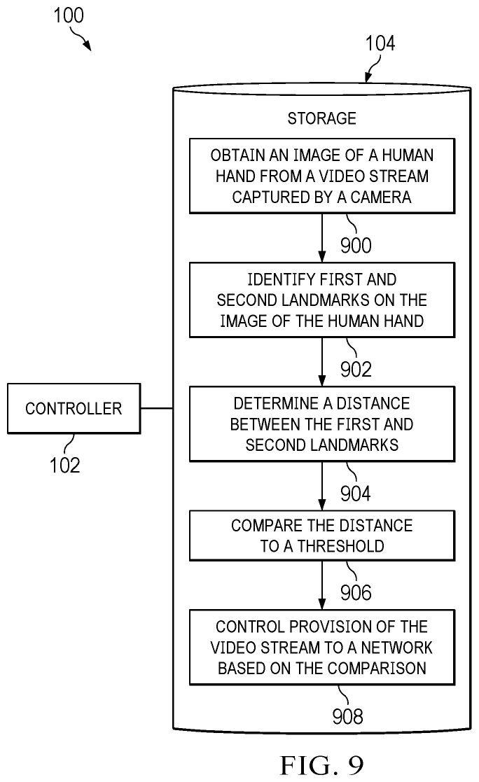

FIGS. 8 and 9 are block diagrams of non-transitory, computer-readable media in accordance with various examples. Specifically, FIG. 8 depicts an example of the electronic device 100, including the controller 102 coupled to the storage 104. The storage 104 stores executable instructions that may be executed by the controller 102. The storage 104 includes executable instruction 800, which causes the controller 102 to obtain an image of a human hand from a video stream captured by a camera. The storage 104 includes executable instruction 802, which causes the controller 102 to control provision of the video stream, an audio stream, or a combination thereof to a network based on a distance of the human hand from the camera as determined using the image.

FIG. 9 depicts an example of the electronic device 100, including the controller 102 coupled to the storage 104. The storage 104 stores executable instructions that may be executed by the controller 102. The storage 104 includes executable instruction 900, which causes the controller 102 to obtain an image of a human hand from a video stream captured by a camera. The storage 104 includes executable instruction 902, which causes the controller 102 to identify first and second landmarks on the image of the human hand. The storage 104 includes executable instruction 904, which causes the controller 102 to determine a distance between the first and second landmarks. The storage 104 includes executable instruction 906, which causes the controller 102 to compare the distance to a programmed threshold. The storage 104 includes executable instruction 908, which causes the controller 102 to control provision of the video stream to a network based on the comparison.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory, computer-readable medium storing executable code, which, when executed by a controller of an electronic device, causes the controller to:
obtain an image of a human hand from a video stream captured by a camera; and
control provision of the video stream, an audio stream, or a combination thereof to a network based on a distance of the human hand from the camera as determined using the image.

2. The computer-readable medium of claim 1, wherein execution of the executable code causes the controller to identify first and second landmarks on the image of the human hand.

3. The computer-readable medium of claim 2, wherein the first and second landmarks are located at a base of an index finger of the human hand and at a base of a pinky finger of the human hand, respectively.

4. The computer-readable medium of claim 2, wherein execution of the executable code causes the controller to determine another distance between the first and second landmarks on the image of the human hand.

5. The computer-readable medium of claim 4, wherein execution of the executable code causes the controller to:
control provision of the video stream, the audio stream, or the combination thereof to the network based on a comparison of the another distance to a threshold.

6. The computer-readable medium of claim 4, wherein execution of the executable code causes the controller to:
halt provision of the video stream, the audio stream, or the combination thereof to the network based on a comparison of the another distance to a threshold; and
provide a substitute video stream, a substitute audio stream, or a combination thereof to the network based on the comparison.

7. The computer-readable medium of claim 4, wherein execution of the executable code causes the controller to determine the another distance using the Pythagorean Theorem.

8. A non-transitory, computer-readable medium storing executable code, which, when executed by a controller of an electronic device, causes the controller to:
obtain an image of a human hand from a video stream captured by a camera;
identify first and second landmarks on the image of the human hand;
determine a distance between the first and second landmarks;
compare the distance to a threshold; and
control provision of the video stream to a network based on the comparison.

9. The computer-readable medium of claim 8, wherein execution of the executable code causes the controller to mute a microphone of the electronic device based on the comparison.

10. The computer-readable medium of claim 8, wherein execution of the executable code causes the controller to provide a substitute video stream to the network in lieu of the video stream.

11. The computer-readable medium of claim 10, wherein execution of the executable code causes the controller to halt providing the substitute video stream to the network and resume providing the video stream to the network.

12. An electronic device, comprising:
a camera to capture a video stream;
a microphone to capture an audio stream;
a network interface;
storage storing executable code; and
a controller coupled to the camera, the microphone, the network interface, and the storage, wherein the controller, upon executing the executable code, is to:
obtain an image of a human hand from the video stream;
identify first and second landmarks on the image of the human hand; and
control provision of the video stream, the audio stream, or a combination thereof to the network interface based on a distance between the first and second landmarks.

13. The electronic device of claim 12, wherein the controller is to halt provision of the video stream, the audio stream, or the combination thereof responsive to the distance being above a threshold.

14. The electronic device of claim 12, wherein the controller is to provide the video stream, the audio stream, or the combination thereof to the network interface responsive to the distance being below a threshold.

15. The electronic device of claim 12, wherein the controller is to use a machine learning model to identify the first and second landmarks.
